(19) United States
(12) Patent Application Publication
(10) Pub. No.: US 2013/0075208 A1
(43) Pub. Date: Mar. 28, 2013

(54) UNI-BODY TYPE HETEROGENEOUS MATERIAL BRAKE DISK AND MANUFACTURING METHOD THEREOF

(71) Applicants: Jae Young Lee, Yongin (KR); Seong Jin Kim, Yongin (KR); Jai Min Han, Ansan (KR); Yoon Cheol Kim, Seoul (KR); Hyun Dal Park, Hwaseong (KR); Kyoung Don Lee, Daegu (KR)

(72) Inventors: Jae Young Lee, Yongin (KR); Seong Jin Kim, Yongin (KR); Jai Min Han, Ansan (KR); Yoon Cheol Kim, Seoul (KR); Hyun Dal Park, Hwaseong (KR); Kyoung Don Lee, Daegu (KR)

(73) Assignees: HYUNDAI MOTOR COMPANY, Seoul (KR); SEOHAN INDUSTRY CO., LTD., Chungcheongbuk-do (KR); KIA MOTORS CORPORATION, Seoul (KR)

(21) Appl. No.: 13/323,548

(22) Filed: Dec. 12, 2011

(30) Foreign Application Priority Data
Sep. 23, 2011 (KR) 10-2011-0096260

(51) Int. Cl. F16D 65/12

(52) U.S. Cl. 188/218 XL

(57) ABSTRACT

Disclosed is a uni-body type heterogeneous material brake disk. In particular, the brake disk includes a friction part configured to be selectively in contact with a pad; and a hub joined with a bearing. More specifically, the friction part and the hub are made of heterogeneous materials through a uni-body type mold. To accomplish this, a connector connecting the friction part and the hub which are vertically spaced apart from each other is laterally spaced apart from the hub, and a bottom of the connector is connected with the hub. In doing so, an elevated platform is formed to prevent a casting from running over between the connector and the hub and an interface made of heterogeneous materials is formed in the connector.

### CROSS-REFERENCE TO RELATED APPLICATION

This application claims under 35 U.S.C. §119(a) the benefit of Korean Patent Application No. 10-2011-0096260 filed on Sep. 23, 2011, the entire contents of which are incorporated herein by reference.

### BACKGROUND

(a) Technical Field

The present disclosure relates to a uni-body type heterogeneous material brake disk integrated with a cost reduction type hub and bearing of low price, as well as a small and medium-sized platform, which is producible for a front wheel brake.

(b) Background Art

FIG. 1 is an exploded perspective view of a brake disk of a vehicle in the conventional art. The brake disk of the vehicle in the conventional art made up of a friction part 20 to which a brake pad is joined and a hub 10 into which a shaft bearing is inserted and the friction part 20 and the hub 10 are joined with a joining bolt 40. Further, the assembled brake disk is joined to the vehicle through a hub bolt 30. That is, the brake disk in the conventional art has a structure in which four components (the friction part, the hub, the joining bolt, and the hub bolt) are assembled through three joining processes as described above.

Since the brake disk in the conventional art is configured with a structure which maintains the same thickness throughout the entire surface of a flange of the hub 10, the brake disk has an unnecessary weight component. In particular, when the conventional structure is actually produced, the friction part 20 and the hub 10 are separately processed and engaged. Thus, impurities may be inserted between the friction part 20 and the hub 10 or a brake may judder due to a joining deviation which is increased by the difference in height of along the surface between both components.

When the impurities exist between the hub 10 and the friction part 20, the joining deviation depending on a difference in height between processed portions may be generated when the hub 10 and the friction part 20 are engaged and the deviation may, be increased when the hub and the disk are engaged with each other at portions having different heights. Accordingly, the probability that the brake will judder is high.

Matters described as the background art are just to improve understanding of the background of the present invention, but it should not be understood that the matters correspond to the related art which is already known to those skilled in the art.

### SUMMARY OF THE DISCLOSURE

The present invention has been made in an effort to provide a uni-body type heterogeneous material brake disk and a manufacturing method thereof that can reduce manufacturing costs by significantly simplifying the brake disk with heterogeneous cast iron materials.

In one aspect, the present invention provides a uni-body type heterogeneous material brake disk including: a friction part contacting a pad; and a hub joined with a bearing, in which the friction part and the hub are made of heterogeneous materials through a uni-body type mold. A connector is utilized to join the friction part and the hub which are vertically spaced apart from each other. The connector is laterally spaced apart from the hub, and the bottom of the connector is connected with the hub, so that an elevated platform is formed to prevent casting from running over between the connector and the hub and an interface made of heterogeneous materials may be formed in the connector, and a manufacturing method thereof.

Preferably, a bearing insertion portion may be formed at the center of the hub, a downward gradient may be formed so that the thickness of the hub protrudes outwards from the bearing insertion portion, and a joining portion into which a hub bolt is inserted may be spaced apart and protrude on the periphery of the bearing insertion portion.

The connector may vertically protrude on the periphery of the hub and the joining portion may be configured so that it does not come in contact with the connector, such that the material of the friction part does not permeate into the joining portion and instead the joining portion is made of the same material as the hub during casting. The joining portion may have a starfish shape around the bearing insertion portion and the top surface of the joining portion may be formed as a horizontal plane.

In some embodiments, in the case of the friction part and the hub, the material of the friction part may be first injected to configure the friction part and thereafter, the material of the hub is injected to configure the hub while forming the interface in the connector, on the same mold. Additionally, the friction part may be made of ferrite cast iron (FC) and the hub may be made of spheroidal graphite cast iron (FCD).

In another aspect, the present invention provides a manufacturing method of a uni-body type heterogeneous material brake disk including: positioning a uni-body type friction part-hub mold so that a friction part faces downward; injecting a friction material only up to an interface of a connector configured to connect the friction part and a hub at the time of injection of the friction part material into the friction part; and injecting a hub material up to the interface at the time of injecting the hub material into the hub.

Preferably, the manufacturing method may further include processing the friction part around a bearing insertion portion of the hub, in which the friction part may be made of ferrite cast iron and the hub may be made of spheroidal graphite cast iron (FCD).

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is an exploded perspective view of a brake disk in the conventional art;

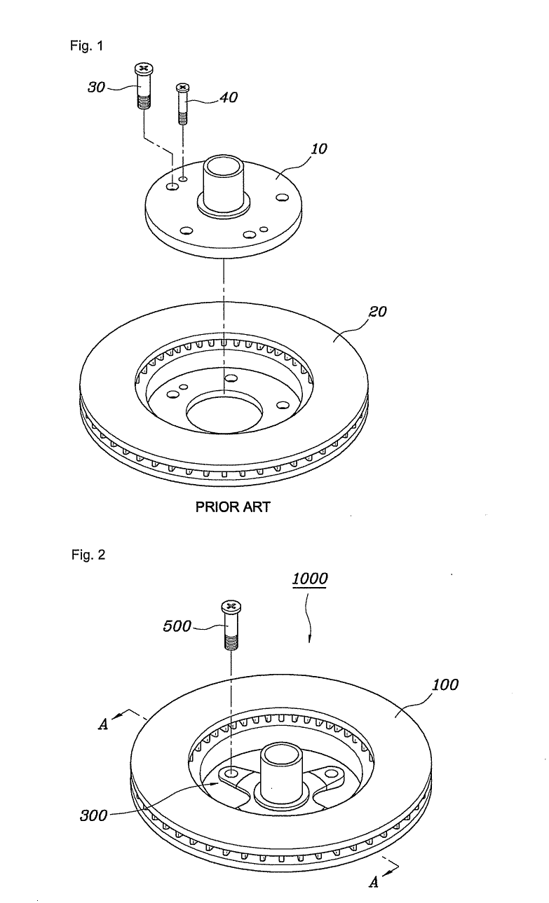

FIG. 2 is a perspective view of a uni-body type heterogeneous material brake disk according to an exemplary embodiment of the present invention;

FIG. 3 is a cross-sectional view of the brake disk taken along line A-A shown in FIG. 2; and

FIGS. 4 to 7 are manufacturing process diagrams for describing a manufacturing method of a uni-body type heterogeneous material brake disk according to an exemplary embodiment of the present invention;

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter, a uni-body type heterogeneous material brake disk and a manufacturing method thereof according to an exemplary embodiment of the present invention will be described with reference to the accompanying drawings.

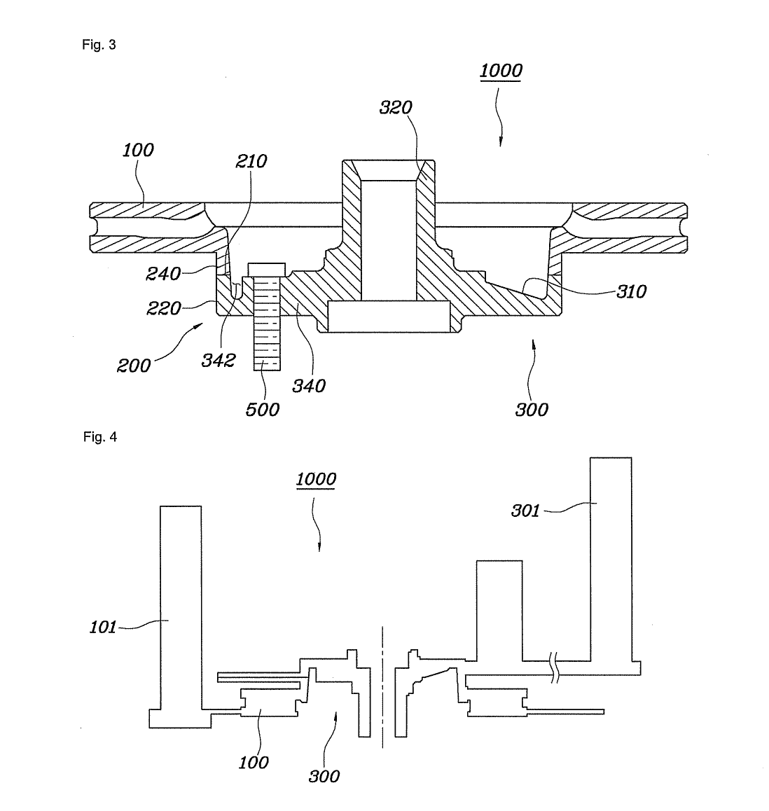

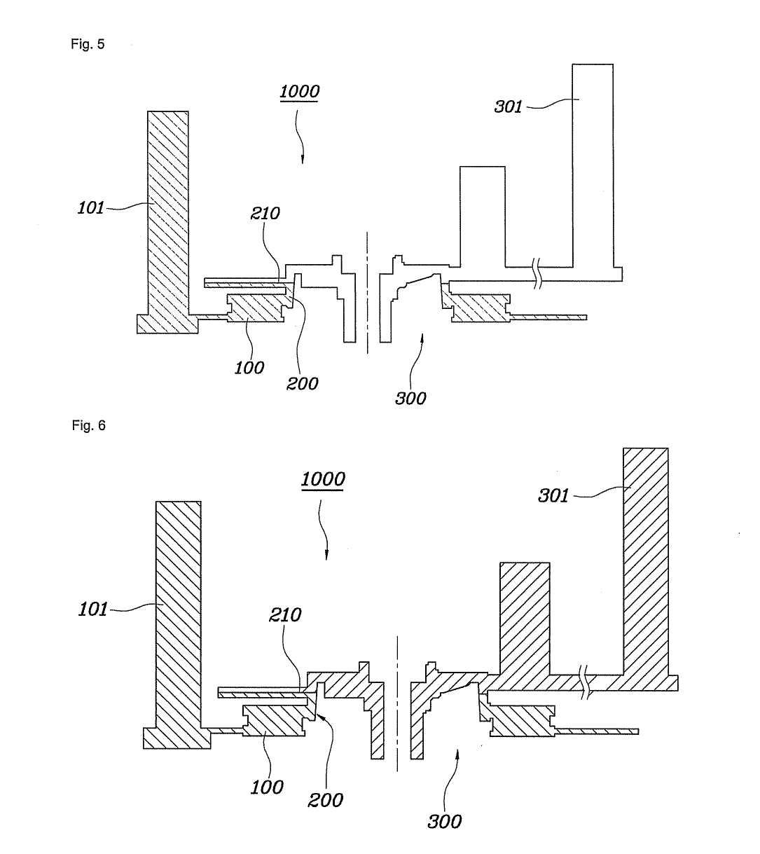

FIG. 2 is a perspective view of a uni-body type heterogeneous material brake disk according to an exemplary embodiment of the present invention and FIG. 3 is a cross-sectional view of the brake disk taken along line A-A shown in FIG. 2.

In the brake disk according to the exemplary embodiment of the present invention which is constituted by a friction part 100 contacting a pad and a hub 300 joined with a bearing, the friction part 100 and the hub 300 are made of heterogeneous materials through a uni-body type mold, while a connector 200 (shown in FIG. 3) connecting the friction part 100 and the hub 300 that are vertically spaced apart from each other, is laterally spaced apart from the hub 300, the bottom of the connector 200 is connected with the hub 300, such that an elevated platform 220 (also shown in FIG. 3) is formed to prevent a casting from running over between the connector 200 and the hub 300 and an interface 210 (shown in FIG. 3) made of heterogeneous materials may be formed in the connector 200.

That is, in the brake disk 1000 according to the exemplary embodiment of the present invention, the hub 300 and the friction part 100 are molded with heterogeneous materials through one mold, the friction part 100 and the hub 300 are vertically spaced apart from each other, and the connector 200 vertically connects them to each other. Of course, the connector 200 may connect them to each other at a slight gradient. In addition, the connector 200 has the interface 210 in the middle thereof, such that both materials of the friction part 100 and the hub 300 coexist in the connector 200. Further, the hub 300 represents a part itself where a hat portion and a hub of a disk in the conventional art would be integrally formed. A driving shaft or a drive wheel is joined to the hub 300 through various methods such as insertion and connection.

Meanwhile, the bottom of the connector 200 is connected with the hub 300 via the connector 200 laterally spaced apart from the hub 300, such that an elevated platform 220 may be formed to prevent the casting from running over between the connector 200 and the hub 300. Therefore, the materials of the friction part 100 and the hub 300 may be selected according to physical characteristics which the respective parts require and both materials are completely separated in the connector, such that both parts constitute a uni-body.

In this case, since the brake disk is engaged by only a hub bolt 500, a tolerance that exists between the friction part 100 and the hub 300 can be removed to prevent a brake juddering phenomenon. Further, man-hours required for assembly decreases thereby reducing manufacturing costs.

Furthermore, a bearing insertion portion 320 is formed at the center of the hub 300, a downward gradient 310 is formed so that the thickness of the hub 300 protrudes outwards from the bearing insertion portion 320, and a joining portion 340 into which the hub bolt 500 is inserted is spaced apart and protrudes on the periphery of the bearing insertion portion 320 to reduce an unnecessary weight of the hub 300 and maintain the joining portion 340 as in the related art, thereby satisfying required durability.

In addition, the connector 200 vertically protrudes on the periphery of the hub 300 and the joining portion 340 is configured so that it does not come in contact with the connector, such that the material of the friction part 100 does not permeate into the joining portion 340 and instead the joining portion 340 may be made of the same material as the hub 300 during casting.

That is, the joining portion 340 into which the hub bolt 500 is inserted is casted so that it does not come in contact with the connector 200, such that a portion 240 in the connector 200 filled with the material of the friction part is separated from the interface 210 and only the material of the hub part flows in along the elevated platform 220 from the interface 210 and a spaced space 342 is provided between the elevated platform 220 and the joining portion 340 to prevent the material of the friction part from flowing into the joining portion 340. The joining portion 340 may have a starfish shape around the bearing insertion portion 320 and the top surface of the joining portion 340 may be formed as a horizontal plane.

Further, in the case of the friction part 100 and the hub 300, the material of the friction part is first injected to form the friction part 100 and thereafter, the material of the hub is injected to form the hub 300 while forming the interface 210 in the connector 200, on the same mold. In addition, the friction part 100 may be made of ferrite cast iron (FC) and the hub 300 may be made of spheroidal graphite cast iron (FCD).

That is, the friction part 100 is made of ferrite cast iron and is injected into the cast up to the interface and thereafter, spheroidal graphite cast iron which is the material of the hub 300 is injected up to the interface, so that both parts are separated as completely different materials to constitute a uni-body. Since ferrite cast iron has excellent friction characteristics, ferrite cast iron forms the friction part and since spheroidal graphite cast iron has excellent elongation characteristics, spheroidal graphite cast iron may be used to form the hub.

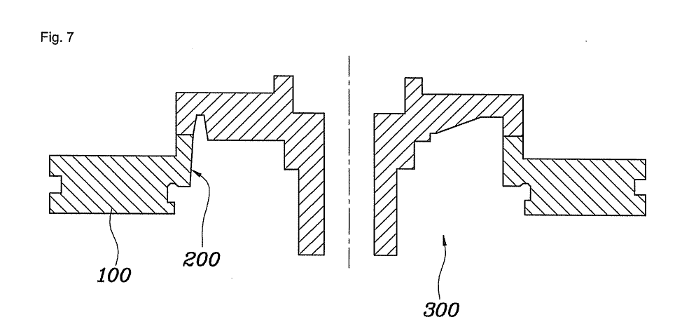

Meanwhile, FIGS. 4 to 7 are manufacturing process diagrams for describing a manufacturing method of a uni-body type heterogeneous material brake disk according to an exemplary embodiment of the present invention. The manufacturing method of the brake disk according to the exemplary embodiment of the present invention includes: a preparation process of positioning a one uni-body type friction part-hub mold so that a friction part 100 faces downward, a friction part configuring process of injecting a friction material only up to an interface 210 of a connector 200 connecting the friction part 100 and a hub 300 at the time of injecting the friction part material into the friction part 100, and a hub configuring process of injecting a hub material up to the interface 210 at the time of injecting the hub material into the hub 300.

In FIG. 4, as the preparation process, first, the uni-body type friction part-hub mold is positioned so that the friction part 100 faces downward. In addition, FIG. 5, as the friction part configuring process, when the friction part material is injected into the friction inlet 101, the friction part material is injected only up to the interface 210 of the connector 200 connecting the friction part 100 and the hub 300.

In FIG. 6, as the hub configuring process, when the hub material is injected into the hub inlet 301, the hub material is injected up to the interface 210. The manufacturing method may further include a processing process of processing the friction part around a bearing insertion portion 320 of the hub 300 as a processing process shown in FIG. 7.

In the processing process, the uni-body type brake disk 1000 is processed around the bearing insertion portion 320 so as to prevent a juddering phenomenon caused due to the generation of a joining tolerance at the time of assembling the hub 300 after processing the friction part 100 in the conventional art. The friction part is made of ferrite cast iron and the hub is made of spheroidal graphite cast iron (FCD).

Advantageously, manufacturing costs can be reduced by significantly simplifying a structure of an existing brake disk assembly with heterogeneous iron cast materials. Further, costs required for a process can be reduced by unifying processes and components required for assembly engagement.

Additionally, the reduces the amount of unnecessary weight elements by implementing a gradient shape at places other than a main weight part and an average assembly deviation is improved when a hub and a friction part are engaged with each other by adjusting a difference in phase between the hub and the friction part through manual operation. Accordingly, since the disk brake is manufactured and processed in a uni-body type structure without needing the engagement of itself with the hub and the friction part, deviation can be prevented from occurring.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A uni-body type heterogeneous material brake disk, comprising:
a friction part configured to come selectively in contact with a pad; and
a hub joined with a bearing,
wherein the friction part and the hub are made of heterogeneous materials via a uni-body type mold, and a connector connecting the friction part and the hub, that are vertically spaced apart from each other, is laterally spaced apart from the hub,
wherein a bottom of the connector is connected with the hub, and an elevated platform is formed to prevent a casting from running over between the connector and the hub, and
wherein an interface is made of heterogeneous materials is formed in the connector.

2. The uni-body type heterogeneous material brake disk of claim 1, wherein a bearing insertion portion is formed at a center of the hub, a downward gradient is formed in which a thickness of the hub protrudes outwards from the bearing insertion portion, and a joining portion into which a hub bolt is inserted is spaced apart and protrudes from a periphery of the bearing insertion portion.

3. The uni-body type heterogeneous material brake disk of claim 2, wherein the connector vertically protrudes from the periphery of the hub and the joining portion is configured so that it does not come in contact the connector, wherein the material of the friction part does not permeate into the joining portion and the joining portion is made of the same material as the hub during casting.

4. The uni-body type heterogeneous material brake disk of claim 2, wherein the joining portion is formed in a starfish shape around the bearing insertion portion and a top surface of the joining portion is formed as a horizontal plane.

5. The uni-body type heterogeneous material brake disk of claim. 1, wherein material of the friction part is first injected to form the friction part and thereafter, material of the hub is injected to form the hub while forming the interface in the connector, on the same mold.

6. The uni-body type heterogeneous material brake disk of claim 1, wherein the friction part is made of ferrite cast iron (FC) and the hub is made of spheroidal graphite cast iron (FCD).
